(19) United States
(12) Patent Application Publication
(10) Pub. No.: US 2011/0139762 A1
(43) Pub. Date: Jun. 16, 2011

(54) ABOVE-GROUND STORAGE TANKS WITH INTERNAL HEAT SOURCE

(75) Inventor: Russ HEBBLETHWAITE, Union Bay (CA)

(73) Assignee: PEARL POINT HOLDINGS LTD., Union Bay (CA)

(21) Appl. No.: 12/964,951

(22) Filed: Dec. 10, 2010

(30) Foreign Application Priority Data
Dec. 10, 2009 (CA) 2,687,818

(51) Int. Cl. H05B 3/02; F26B 3/30; B65D 90/02

(52) U.S. Cl. 219/213

(57) ABSTRACT

An above-ground storage tank defining an interior volume includes an internal containment chamber and a flameless heat source within the containment chamber to heat the tank interior volume.

### CROSS REFERENCE TO RELATED APPLICATION

This application claims the priority benefit of Canadian Patent Application 2,687,818 filed on Dec. 10, 2010 entitled “Above-Ground Storage Tanks with Internal Heat Source”, the contents of which are incorporated herein by reference.

### FIELD OF THE INVENTION

The present invention is directed to above-ground storage tanks with internal containment chambers having a flameless heat source.

### BACKGROUND

The storage of materials, including petroleum products and waste materials, in the upstream and downstream petroleum industry is dependent on primary containment devices, such as underground and above-ground storage tanks. Such tanks typically include secondary containment measures, which are required in some jurisdictions.

Many above-ground storage tanks are internally heated to avoid freezing or to reduce viscosity of the tank contents, which encourages phase separation. Conventional tank heating systems utilize burners and firetubes. A firetube typically involves a single pass tube running through the tank interior from an exterior burner assembly. Hot flue gases from the burner pass through the firetube, through the tank, and exit an exterior chimney or stack.

Many jurisdictions require secondary containment for above-ground storage tanks, which may be satisfied in many cases with double walled tanks. However, a fire tube represents another opening in the tank wall, requiring welds to both inner and outer tanks, and another potential point of failure for fluid containment.

It is not uncommon to have tank fires or explosions where the fluid level in the tank drops below the firetube within the tank. Burner shutdown switches associated with fluid level floats are expensive installations, and suffer their own failures. In addition to safety concerns, burner and firetube heater assemblies are inefficient, resulting in large energy costs and increased greenhouse gas emissions.

There is a need in the art for above-ground storage tanks with flameless heating systems, which may mitigate the problems of the prior art.

### SUMMARY OF THE INVENTION

In one aspect, the invention comprises an above-ground storage tank defining an interior volume and an internal containment chamber, which is formed by a containment wall, and a sufficient heat source within the containment chamber to heat the tank interior volume. In one embodiment, the heat source comprises a flameless heat source, such as a catalytic infrared heater.

In one embodiment, the above-ground storage tanks comprises:
(a) a tank roof, a tank floor, a primary tank and a secondary tank, and an interstitial space therebetween;
(b) a containment chamber formed by a primary chamber wall and a secondary chamber wall, forming a chamber interstitial space therebetween, and an exterior door assembly;
(c) a flameless heat source disposed within the containment chamber;
(d) a heat transfer element disposed within the chamber interstitial space.

In another aspect, the invention comprises a method of heating an above-ground fluid storage tank, said tank having an interior volume and a containment chamber formed by a containment wall separating the containment chamber from the tank interior volume, the method comprising the steps of heating the containment wall by radiative means, and conducting heat into the tank interior volume from the containment wall.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. The drawings are briefly described as follows:

FIG. 1A shows a vertical cross-section through one embodiment of a tank of the present invention. FIG. 1B is a horizontal cross-section of the containment chamber.

FIG. 2 shows a vertical cross-section through one embodiment of a double-walled tank of the present invention.

FIG. 3 shows a horizontal cross-section through the embodiment shown in FIG. 2, along line III-III.

FIG. 4 shows a vertical cross-section through another alternative embodiment, where the containment chamber is raised off the tank floor.

### DETAILED DESCRIPTION OF PREFERRED EMBODIMENTS

The invention relates to above-ground storage tanks. When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

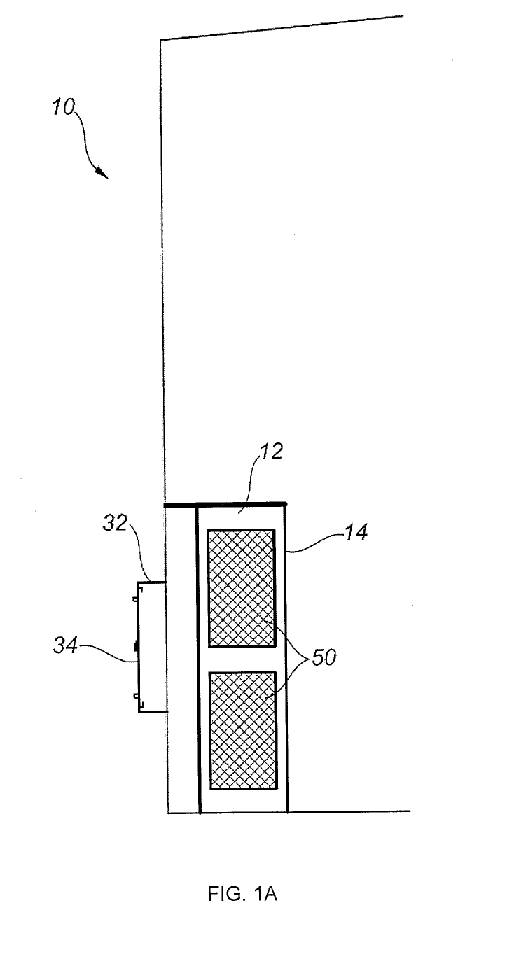

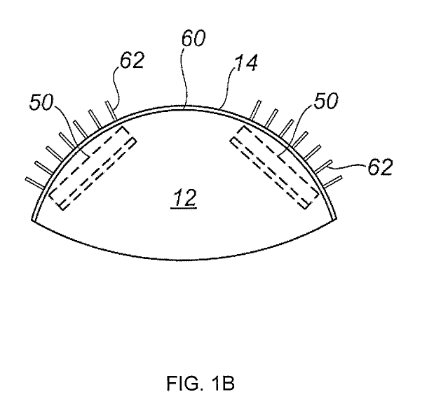

Standard above-ground fluid storage tanks with spill containment chambers are known. Suitable tanks and chambers are described in Canadian Patent No. 2,196,842, the entire contents of which are incorporated herein by reference, where permitted. FIG. 1A depicts a fluid storage tank (10) having a spill containment chamber (12), which is defined by containment wall (14) which completely separates the chamber from the interior volume of the tank. A heat source (50) is included within the containment chamber.

In one embodiment, the invention comprises an above-ground storage tank defining an interior volume and comprising:
(a) a tank roof, a tank floor, a primary tank and a secondary tank, and an interstitial space therebetween;
(b) an containment chamber formed by a primary chamber wall and a secondary chamber wall, forming a chamber interstitial space therebetween, and an exterior door assembly;
(c) a flameless heat source disposed within the containment chamber;
(d) a heat transfer element disposed within the chamber interstitial space.

As used herein, “flameless heat” means heat generated without the rapid oxidation characteristic of fire or combustion. Flameless heat may be generated, for example and without limitation, by chemical reaction, electrical resistance, or magnetic induction. The flameless heat source (50) may comprise a catalytic heater, such as a propane or natural gas powered catalytic heater, which are well known in the industry. Catalytic heaters operate by controlled oxidation of a fuel, at a temperature below the ignition point of the fuel. Suitable catalytic heaters may include Cata-Dyne™ heaters (CCI Thermal Technologies Inc.). The size and number of heaters (50) contained within the containment chamber may be calculated by one skilled in the art. Once the tank interior volume is known and the desired temperature to be maintained, then one may calculate the heat required. Other factors which may influence the determination of heat required may include the presence or quality of insulation on the tank and the expected range of exterior temperatures where the tank is to be used or installed. The determination of the quantum of heat required is well within the ordinary skill of one skilled in the art without undue experimentation.

The fuel gas inlet lines for the catalytic heaters may be run into the containment chamber in a conventional fashion, such as through the door assembly, or through the tank wall (or both walls for dual-walled tanks) below the door assembly. Alternative and suitable sources of flameless heat include electric heaters or inductive heat sources.

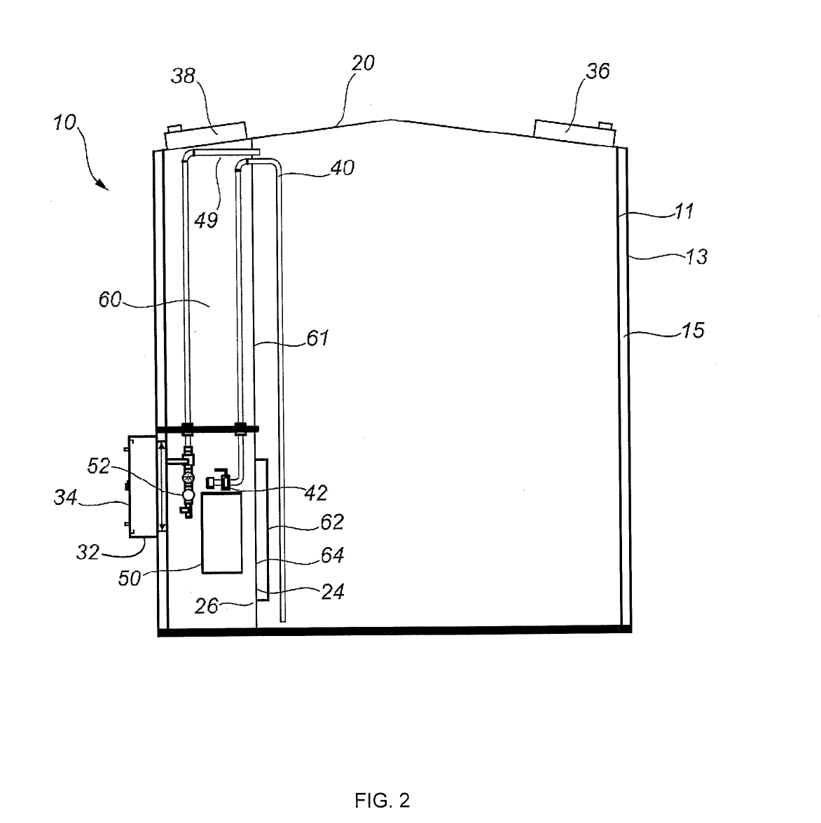

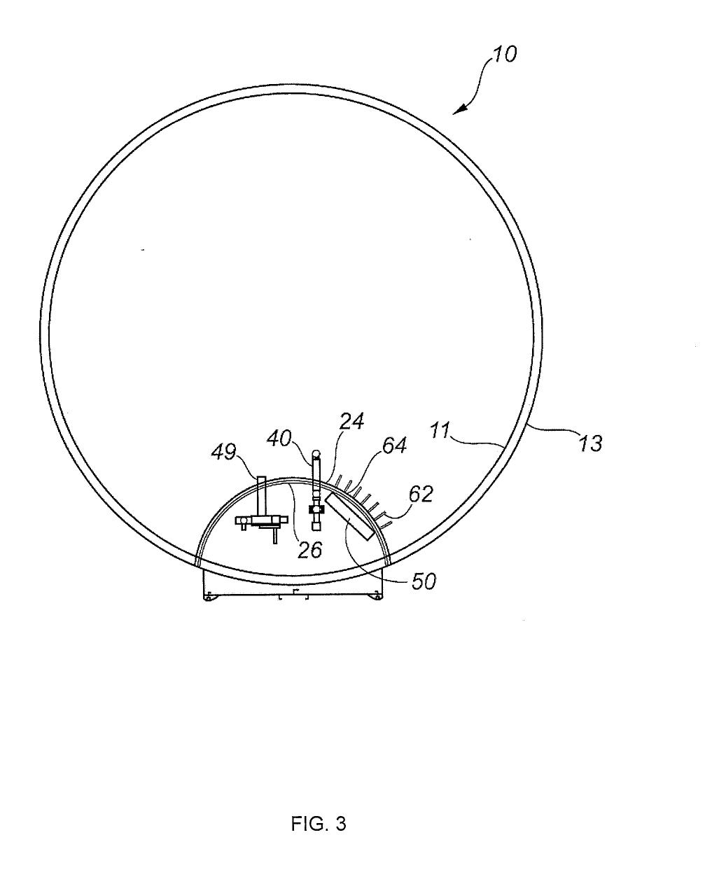

As shown in FIGS. 2 and 3, in one embodiment, a storage tank (10) has a primary tank wall (11), and a secondary tank wall (13), which defines a tank interstitial space (15) therebetween. As required by regulation in Alberta, the floor (18) is also double-walled, while the roof (20) is not as it is considered part of the freeboard zone of the tank.

The containment chamber (12) is created by a chamber primary wall (24) and a chamber secondary wall (26), which define a chamber interstitial space therebetween (28). The chamber walls (24, 26) are attached to the tank walls (11, 13) in a fluid-tight manner, such as by a suitable welding process. The attachments between the tank and containment chamber primary and secondary walls may be varied, as described in Applicant's co-pending Canadian patent application no. 2,682,651, filed on Oct. 14, 2009, the contents of which are incorporated herein by reference, where permitted.

The containment chamber (12) is differentiated from a conventional firetube in that it does not serve as a conduit for products of combustion, and does not require an inlet and outlet. The containment chamber comprises a discrete and contiguous space disposed substantially within the tank interior volume, and is primarily used to house valves and piping, and to contain spills. In the present invention, it also becomes the heat source for the tank itself.

Access to the containment chamber (12) is provided by a door assembly which passes through the primary and secondary tank walls (11, 13). The door assembly may comprise a box (32) having a door (34). The door assembly can either be formed from the tank secondary wall material, or, be a completely separate manufactured component that is welded to the exterior of the tank secondary wall, over a door opening cut through both secondary and primary walls. The door opening must then be framed between the primary and secondary tank walls to re-seal the interstitial space. This doorway opening provides access into the containment chamber (12).

In one embodiment, the tank comprises an ancillary containment chamber (60) formed by a single walled enclosure (61). The ancillary chamber is formed adjacent to and above the main containment chamber. The single walled enclosure (61) of the ancillary chamber extends upwards and attaches to the tank roof (20). The tank may comprises pipe and valve assemblies, such as those described and illustrated in Canadian patent application no. 2,682,651. In one embodiment, the tank comprises two pipe and valve assemblies: a suckout pipe (40) and an overflow pipe (49).

An overflow pipe (49) originates in the freeboard zone, near the fluid line marking maximum capacity of the tank, and passes into the ancillary chamber. The overflow pipe (49) then continues into the containment chamber, and terminates in a high level shutdown switch (52). This switch (52) may include sensors which regulate inflows into the tank, or may be connected to transmitters (not shown) which transmit a wireless or radio alarm signal, as is well known in the art.

The suckout pipe (40) originates near the tank floor, rises to the freeboard zone, where it passes through the ancillary chamber wall (61) and into the ancillary chamber (60). It then passes through into the containment chamber, where it terminates with a suckout valve (42).

Because the single walled enclosure (61) is ancillary to the double walled tank and containment chamber, the incursions into the interstitial spaces is contained by the ancillary chamber. The access hatch (38) through the tank roof (20) provides direct access into the ancillary chamber.

As may be seen in FIGS. 2 and 3, both the suckout pipe and valve assembly and the overflow pipe and valve assembly do not compromise the integrity of the tank interstitial space, as they pass directly into the containment chamber, which is itself double-walled, from the ancillary chamber.

Catalytic heaters typically produce heat substantially by generating infrared energy, thereby transferring heat by radiative means. Therefore, in one embodiment, the heaters are oriented within the containment chamber to be directed at the secondary containment wall. It is also expected that the air temperature within the containment chamber would be elevated, and would contribute to heating the secondary containment wall.

Heat transfer from the secondary containment wall, to the primary containment wall, and into the tank interior volume is then by conductive means. The containment chamber would thus heat the fluid within the tank in the immediate vicinity of the containment wall, which would then flow convectively within the tank. In one embodiment, heat radiating fins (62) may be attached to the primary containment wall (24), projecting into the tank interior volume.

Although the containment wall is preferably double-walled for fluid containment reasons, the creation of a containment interstitial space does not facilitate heat transfer into the tank interior volume. Therefore, in one embodiment, heat transfer elements (64) may be provided within the interstitial space to provide heat conductive paths across the interstitial space. The heat transfer elements are preferably made of materials which high heat conductivity. For example, a metal honeycomb structure, or a metal mesh in contact with both the secondary and primary containment walls within the interstitial space would provide heat conduits across the interstitial space. In addition, the heat insulating effect of the interstitial space may be reduced by minimizing the width of the interstitial space.

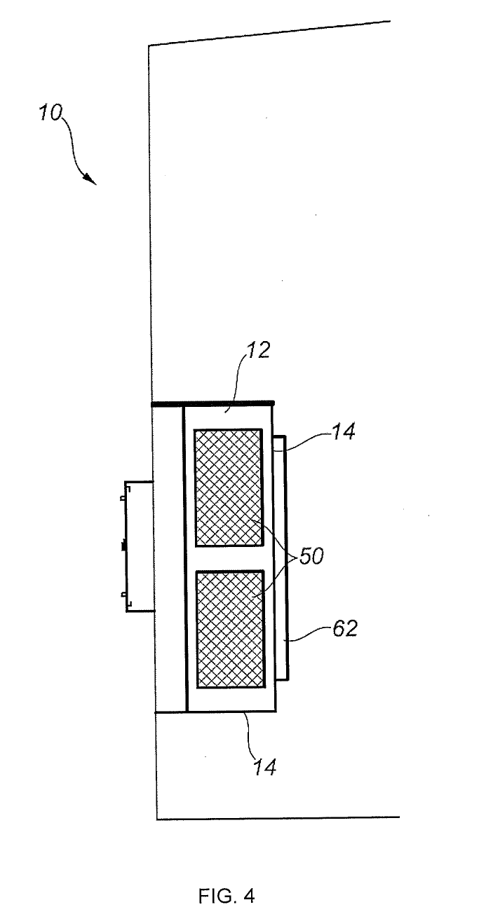

In a further alternative, as shown in FIG. 4, the containment chamber may be raised from the tank floor, providing additional surface area to conduct heat to the tank interior volume.

In one embodiment, the tank comprises fluid detection sensors (not shown) in the tank interstitial space, the chamber interstitial space, or both. If the tank interstitial space, and the chamber interstitial space are connected or contiguous, it may possible to implement only one fluid detection sensor within either the tank or the chamber interstitial space. Suitable fluid detection sensors are well known in the art.

As will be apparent to those skilled in the art, various modifications, adaptations and variations of the foregoing specific disclosure can be made without departing from the scope of the invention claimed herein.

What is claimed is:

1. An above-ground storage tank having an interior volume and an internal containment chamber separated from the tank interior volume by a containment wall, said tank comprising a flameless heat source disposed within the containment chamber.

2. The tank of claim 1 wherein the tank is a double-walled tank and comprises:
(a) a tank roof, a tank floor, a primary tank wall and a secondary tank wall, and an interstitial space therebetween;
(b) the containment chamber formed by a primary chamber wall and a secondary chamber wall, forming a chamber interstitial space therebetween, and an exterior door assembly;
(c) the flameless heat source mounted to the secondary chamber wall.

3. The tank of claim 1 wherein the flameless heat source comprises at least one catalytic heater.

4. The tank of claim 1 further comprising heat transfer elements disposed within the chamber interstitial space.

5. The tank of claim 4 further comprising heat radiating fins mounted to the primary chamber wall, extending into the tank interior volume.

6. The tank of claim 4 or 5 wherein the heat transfer elements comprises a metal honeycomb or mesh in contact with both the secondary containment wall and the primary containment wall.

7. A method of heating an above-ground fluid storage tank, said tank having an interior volume and a containment chamber formed by a containment wall separating the containment chamber from the tank interior volume, the method comprising the steps of heating the containment wall by radiative means, and conducting heat into the tank interior volume from the containment wall.

8. The method of claim 7 wherein the containment wall is heated by radiative heat from a catalytic heater.
